(19) United States
(12) Patent Application Publication
(10) Pub. No.: US 2025/0119046 A1
(43) Pub. Date: Apr. 10, 2025

(54) DIRECT-DRIVE SYSTEM

(71) Applicant: AAC Microtech (Changzhou) Co., Ltd.

(72) Inventors: Yu Qin, Shenzhen (CN); Weiling Shi, Shenzhen (CN); Shun Guo, Shenzhen (CN); Lin Qian, Shenzhen (CN)

(21) Appl. No.: 17/919,532

(22) PCT Filed: Jul. 20, 2022
(86) PCT No.: PCT/CN2022/106641

§ 371 Date: Oct. 18, 2022

(30) Foreign Application Priority Data
Jun. 30, 2022 (CN) 202221689498.3

(51) Int. Cl. H02K 41/03; H02K 5/10

(52) U.S. Cl. CPC H02K 41/031; H02K 5/10

(57) ABSTRACT

A direct-drive system, including a base provided with a guide rail; a slider arranged on the guide rail; a mover assembly including a mover arranged on the slider and a magnet arranged on an inner side wall of the mover; a stator assembly including a stator support arranged on the base and a stator connected to the stator support; and a blocking member. The stator is inserted into the mover and arranged opposite to and spaced from the magnet. The blocking member includes a first end connected to a side of the base away from the stator support and a second end obliquely extends towards the stator and spaced from the slider. The blocking member effectively prevents foreign matters from falling onto the guide rail, thereby preventing blockage of the slider by the foreign matters on the guide rail, and thus bringing a good protective effect and effectively improving an operation accuracy of the guide rail and prolonging a service life.

### TECHNICAL FIELD

The present invention belongs to the technical field of motors, and in particular, to a direct-drive system.

### BACKGROUND

For a direct-drive system in the related art, a guide rail has no protective structure, and foreign matters may enter the guide rail system to result in blockage of a mover slider; and, dust particles may fall between the slider and the guide rail to result in wearing of the guide rail, thereby affecting an operation accuracy and a service life of the guide rail.

With respect to the above problems, there is a need to provide a direct-drive system that is reasonably designed and can effectively alleviate the above problems.

### SUMMARY

An embodiment of the present invention provides a direct-drive system, including: a base provided with a guide rail; a slider slidable on the guide rail; a mover assembly including a mover arranged on the slider and a magnet arranged on the mover; a stator assembly including a stator support arranged on the base and a stator connected to the stator support; and a blocking member. The stator is inserted into the mover and arranged opposite to and spaced from the magnet; and the magnet interacts with the stator to drive the mover assembly to move on the base by means of the guide rail. The blocking member, includes a first end that is connected to a side of the base away from the stator support, and a second end that obliquely extends towards the stator and is spaced from the slider.

As an improvement, the blocking member includes a mounting portion and a blocking portion. The mounting portion is arranged at an outer side wall of the base away from the stator support, and the blocking portion obliquely extends from an end of the mounting portion towards the stator support and towards the stator.

As an improvement, an orthographic projection of the blocking portion onto the stator falls at least partially into the stator.

As an improvement, an end of the blocking portion facing towards the stator is located at an inner side of an outer wall of the stator facing away from the stator support.

As an improvement, the blocking portion protrudes from the guide rail.

As an improvement, a cross section of the blocking member in a direction perpendicular to a motion direction of the mover assembly is L-shaped, arc-shaped, or parabola-shaped.

As an improvement, the slider includes a bottom wall, a top wall, a first side wall connected to a first end of the top wall and a first end of the bottom wall, and a second side wall connected to a second end of the top wall and a second end of the bottom wall. The top wall is connected to the mover, the bottom wall is slidable on the guide rail, the first side wall faces towards the blocking member, and the second side wall faces away from the blocking member. The first side wall obliquely extends from an end close to the bottom wall towards the top wall and the stator support, and the first side wall is spaced from the blocking member.

As an improvement, an inclination angle of the first side wall matches an inclination angle of the blocking member.

As an improvement, the blocking member is detachably provided on the base.

### BRIEF DESCRIPTION OF DRAWINGS

FIG. 1 is a schematic structural diagram of a direct-drive system according to an embodiment of the present invention;

FIG. 2 is a sectional view of the direct-drive system shown in FIG. 1;

FIG. 3 is a schematic structural diagram of a blocking member according to another embodiment of the present invention; and

FIG. 4 is a schematic structural diagram of a slider according to another embodiment of the present invention.

### DESCRIPTION OF EMBODIMENTS

To enable those skilled in the art to better understand the technical solution of the present invention, the present invention is described in detail below with reference to the accompanying drawings and embodiments.

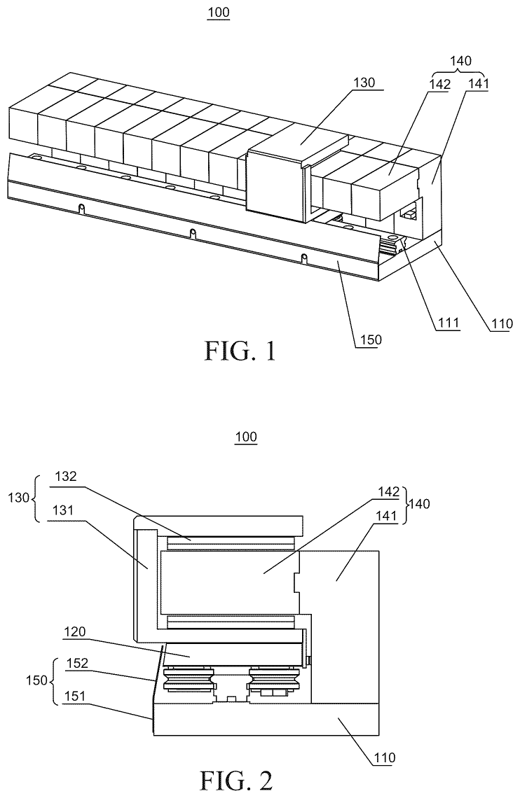

As shown in FIG. 1 and FIG. 2, an embodiment provides a direct-drive system 100. The direct-drive system 100 includes a base 110, a slider 120, a mover assembly 130, and a stator assembly 140. The base 110 is provided with a guide rail 111. The slider 120 is slidable on the guide rail 111. The mover assembly 130 includes a mover 131 and a magnet 132 arranged at the mover 131. The mover 131 is arranged on the slider 120. The stator assembly 140 includes a stator support 141 and a stator 142 connected to the stator support 141. The stator support 141 is arranged on the base 110. The stator 142 is inserted into the mover 131 and arranged opposite to and spaced from the magnet 132. The magnet 132 interacts with the stator 142 to drive the mover assembly 130 to move on the base 110 by means of the guide rail 111. The stator is generally a wound coil.

As shown in FIG. 1 and FIG. 2, the direct-drive system 100 further includes a blocking member 150. A first end of the blocking member 150 is connected to a side of the base 110 away from the stator support 141, and a second end of the blocking member 150 obliquely extends towards the stator 142 and is spaced from the slider 120.

According to the direct-drive system of the present invention, with the arrangement of the blocking member, a first end of the blocking member is connected to the side of the base away from the stator support, and a second end of the blocking member obliquely extends toward a direction close to the stator and is spaced from the slider, so as to effectively prevent foreign matters from falling onto the guide rail, thereby preventing blockage of the slider by the foreign matters on the guide rail, and thus bringing a good protective effect and effectively improving an operation accuracy of the guide rail and prolonging a service life.

It is to be noted that an inclination angle of the blocking member is not limited, provided that it can prevent foreign matters from falling onto the guide rail. For example, in one embodiment, the inclination angle (an angle with respect to a vertical direction) may range from 10° to 25°, which is not limited in this embodiment.

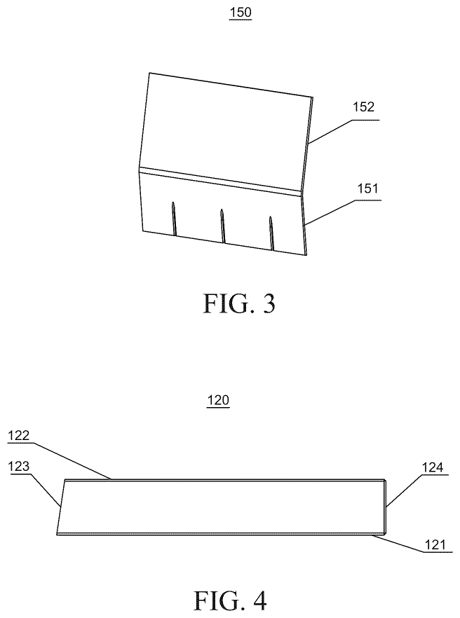

For example, as shown in FIG. 1, FIG. 2, and FIG. 3, for an exemplary structure of the blocking member 150, the blocking member 150 includes a mounting portion 151 and a blocking portion 152. The mounting portion 151 is arranged at an outer side wall of the base 110 away from the stator support 141. That is, as shown in FIG. 1, the mounting portion 151 is arranged at a side wall at a left side of the base 110. The blocking portion 152 obliquely extends from an end of the mounting portion 151 towards the stator support 141 and towards the stator 142. That is, as shown in FIG. 2, the blocking portion 152 obliquely extends upward and inward.

In an example, as shown in FIG. 2, a cross section of the blocking member 150 in a direction perpendicular to a motion direction of the mover assembly is L-shaped. Certainly, in addition, the cross section of the blocking member 150 may also be arc-shaped, parabola-shaped, or the like, which is not limited in this embodiment.

For example, as shown in FIG. 2, an orthographic projection of the blocking portion 152 onto the stator 142 falls at least partially into the stator 142. That is, as shown in FIG. 2, part of the blocking portion 152 is closer to the inner side than the stator 142. In this way, foreign matters that fall off from the stator can be prevented from entering the guide rail 111, thereby further improving the operation accuracy of the guide rail and prolonging the service life.

In an example, as shown in FIG. 2, an end of the blocking portion 152 facing the stator 142 is located at an inner side of an outer wall of the stator 142 away from the stator support 141. That is, as shown in FIG. 2, an upper end of the blocking portion 152 is closer to the inner side than the left side of the stator 142, thereby effectively preventing foreign matters that fall off from the stator fro entering the guide rail 111, and thus further improving the operation accuracy of the guide rail and prolonging the service life.

For example, as shown in FIG. 2, the blocking portion 152 protrudes from the guide rail 111. That is, as shown in FIG. 2, the blocking portion 152 is higher than the guide rail 111, thereby preventing most foreign matters and dust from a side surface from entering the guide rail 111, thus further improving the operation accuracy of the guide rail and prolonging the service life.

It is to be noted that a dimension of the blocking portion protruding from the guide rail 111 is not limited, provided that the blocking portion is slightly higher than the guide rail 111 to prevent foreign matters and dust from the side surface from entering the guide rail 111, which is not limited in this embodiment.

For example, as shown in FIG. 2 and FIG. 4, the slider 120 includes a bottom wall 121, a top wall 122, a first side wall 123 connected to a first end of the top wall 122 and a first end of the bottom wall 121, and a second side wall 124 connected to a second end of the top wall 122 and a second end of the bottom wall 121. The top wall 122 is connected to the mover 131, the bottom wall 121 is slidable on the guide rail 111, the first side wall 123 faces towards the blocking member 150, and the second side wall 124 faces away from the blocking member 150.

As shown in FIG. 2 and FIG. 4, the first side wall 123 obliquely extends from an end close to the bottom wall 121 towards the top wall 122 and the stator support 142. That is, in this embodiment, as shown in FIG. 2, a side surface of the slider 120 is also designed to incline at a certain angle, so as to match the blocking member 150, thereby effectively preventing foreign matters from falling onto the guide rail 111, thus further improving the operation accuracy of the guide rail and prolonging the service life.

In an example, as shown in FIG. 2 and FIG. 4, an inclination angle of the first side wall 123 matches an inclination angle of the blocking member 150. In an example, the inclination angle of the first side wall 123 is consistent with the inclination angle of the blocking member 150.

For example, as shown in FIG. 1 and FIG. 2, in order to facilitate disassembly to timely clean accidental foreign matters, the blocking member 150 is detachably arranged on the base 110. For example, the blocking member 150 may be detachably connected to the base 110 by clamping, screwing, or other means, which is not limited in this embodiment.

It should be understood that the above embodiments are merely exemplary embodiments intended to illustrate the principle of the present invention, but the present invention is not limited thereto. For those of ordinary skill in the art, various variations and improvements can be made without deviating from the spirit and essence of the present invention, and all these variations and improvements shall fall within a scope of the present invention.

1. A direct-drive system, comprising:
a base provided with a guide rail;
a slider slidable on the guide rail;
a mover assembly comprising a mover arranged on the slider and a magnet arranged on the mover;
a stator assembly comprising a stator support arranged on the base and a stator connected to the stator support; and
a blocking member,
wherein the stator is inserted into the mover and arranged opposite to and spaced from the magnet; and the magnet interacts with the stator to drive the mover assembly to move on the base by means of the guide rail, and
wherein the blocking member, comprises a first end that is connected to a side of the base away from the stator support, and a second end that obliquely extends towards the stator and is spaced from the slider.

2. The direct-drive system as described in claim 1, wherein the blocking member comprises a mounting portion and a blocking portion; and wherein the mounting portion is arranged at an outer side wall of the base away from the stator support, and the blocking portion obliquely extends from an end of the mounting portion towards the stator support and towards the stator.

3. The direct-drive system as described in claim 2, wherein an orthographic projection of the blocking portion onto the stator falls at least partially into the stator.

4. The direct-drive system as described in claim 3, wherein an end of the blocking portion facing towards the stator is located at an inner side of an outer wall of the stator facing away from the stator support.

5. The direct-drive system as described in claim 2, wherein the blocking portion protrudes from the guide rail.

6. The direct-drive system as described in claim 1, wherein a cross section of the blocking member in a direction perpendicular to a motion direction of the mover assembly is L-shaped, arc-shaped, or parabola-shaped.

7. The direct-drive system as described in claim 1,
wherein the slider comprises a bottom wall, a top wall, a first side wall connected to a first end of the top wall and a first end of the bottom wall, and a second side wall connected to a second end of the top wall and a second end of the bottom wall;
wherein the top wall is connected to the mover, the bottom wall is slidable on the guide rail, the first side wall faces towards the blocking member, and the second side wall faces away from the blocking member; and
wherein the first side wall obliquely extends from an end close to the bottom wall towards the top wall and the stator support, and the first side wall is spaced from the blocking member.

8. The direct-drive system as described in claim 7, wherein an inclination angle of the first side wall matches an inclination angle of the blocking member.

9. The direct-drive system as described in claim 1, wherein the blocking member is detachably provided at the base.
